(19) United States
(12) Patent Application Publication
(10) Pub. No.: US 2010/0318899 A1
(43) Pub. Date: Dec. 16, 2010

(54) DESIGN EDITING APPARATUS AND METHOD AND DESIGN EDITING PROGRAM

(75) Inventor: Atsushi Kitada, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/518,069

(22) PCT Filed: Dec. 6, 2007
(86) PCT No.: PCT/JP2007/073985

§ 371 Date: Jun. 5, 2009

(30) Foreign Application Priority Data
Dec. 7, 2006 (JP) 2006-330691

(51) Int. Cl. G06F 17/00

(52) U.S. Cl. 715/243

(57) ABSTRACT

A page design edited by a general user who does not have an enough design knowledge is not always preferable in terms of a design. Since there is no means for effectively notifying the user of editing functions which a page design application has, there is a case where the user cannot fully use those functions but has completed the edition in the undesirable page design. To solve such a problem, the invention provides a function for displaying a plurality of page design candidates obtained by executing a page design modifying process to a designated layout constructing object as variations and enabling the user to select a desired page design from them.

### TECHNICAL FIELD

The invention relates to a design editing apparatus for displaying text data or image data in a storage unit onto a display.

### BACKGROUND ART

Hitherto, various kinds of application software which are used to produce page designs such as poster, catalog, presentation data, postcard, leaflet, advertisement, and the like and operate in a personal computer have been released. A function of a DTP (Desk Top Publishing) which had widely been known hitherto has been installed in those software to form the page designs. That is, besides functions such as layout edition of page design component elements (e.g. image, character, and clipart) and shadow and decoration effect to the image or character, a printing function for outputting to a printer has been equipped.

The page design applications can be classified into two applications, that is, expensive application having an advanced function which is used by a professional graphic designer and relatively reasonable application for general use adapted to execute a simple operation/process. In the former application, there is such a tendency that importance is attached to widths and kinds of functions rather than an operability so that an intention of the graphic designer is more accurately reflected to a larger extent. For the general user, such an application is an advanced type of product which it also takes a long time to study. In the latter application, the user which can operate to a certain extent an OS (Operating System) on the personal computer and office applications such as word processor and spreadsheet is also regarded as a target. Therefore, such a product that the operations which are executed until the relevant page design is printed are simplified and a forming flow which is executed until not only the editing operation but also a print setting are performed are guided exists.

In the application for general use, in order to realize a page design of high quality by the simple operation, raw materials such as design templates (sample patterns) which have previously been designed, clipart, and photograph for efficiently produce the page design are often provided. The user executes a procedure for selecting a design template close to an image as a completed form of a target page design and completing the page design by properly executing an edition such as replacement of photographs, text edition, addition of other raw materials, application of a decoration effect, or the like. For the general user who is not sufficiently skilled in layout design/color design knowledge, it takes a very long time until he/she forms a desired page design from a substantial blank state and the formed page design does not always result in a page design which is preferable as a design. The page design which is preferable as a design denotes a state where the accurate contents are transferred, easy reading performance is assured, and if possible, a strong impression is satisfied for the reader and observer of the page design. In order to form the page design in such a state, fundamental design knowledge and know-how about a layout and a color arrangement are necessary.

In recent years, in the page design forming operation, a method whereby a desired design is selected from the design templates which have previously been provided and the editing operation is completed has become firmly established. There have been disclosed several techniques in which by designating a design image which becomes an impression that is given to the reader and observer of the page design in addition to such a method, variations of the layout and color arrangement of the page design are produced and the user is allowed to select a page design which is close to a desired image from the produced variations.

In the Official Gazette of Japanese Patent Application Laid-Open No. H07-306935, there has been disclosed a technique in which the user selects a color arrangement image adapted to decide an impression of the page design according to the color arrangement, thereby deciding the most important color which the relevant image has, other colors which are matched with the most important color are produced and combined, and the colors of the page design are arranged. For this purpose, there is prepared a database in which the color arrangement images to be selected by the user have been stored. Thus, the impression of the page design which is formed can be made to easily approach the user's desired impression.

In the Official Gazette of Japanese Patent Application Laid-Open No. H09-146948, a technique for deciding a page layout based on a desire of the layout of page design component elements received from the user has been disclosed. To realize such a technique, restriction items regarding the layout of the page design component elements are held as a rule base, and there is prepared a layout means for arranging the page design component elements based on the restriction items into a layout region which is designated by the user. By such means, page design component elements which are newly formed and inserted can be properly arranged.

In the Official Gazette of Japanese Patent Application Laid-Open No. H11-232474, a page design forming technique in which based on page design conditions received from the user, variations of design templates which satisfy those conditions are displayed, and the page design and a page design raw material designated by the user are combined has been disclosed. The user selects a page design which is close to an image of a desired completed form from the variations, and thereafter, component elements such as image, text, and the like designated by the user are properly added and replaced, thereby completing the image.

In recent years, application software for dynamically producing a page design based on the page component elements, an object, and conditions designated by the user has been released. In such an application, means for inputting an image, a clipart, a sentence, and a direction of a page which are used on the relevant page design, thereby dynamically producing hundreds of page designs and allowing the user to select a desired page design is provided. The produced page designs are thumbnail-displayed onto two-dimensional coordinates in which an axis of abscissa indicates the presence or absence of a background design and an axis of ordinate indicates a magnitude of a subject. By such a displaying method, when the user himself selects the desired design, he can easily image in what manner the produced page is expressed at which position in a group of produced designs. In addition to it, with respect to the selected page design, the color arrangement image showing an impression of the page design can be selected. As a background of such a color arranging technique, a color palette and a plurality of combinations (color variations) using the colors on the color palette have been defined every color arrangement image. The user selects the selected color arrangement image and the color variation belonging to the selected color arrangement image. By those techniques, the page design producing operation by the user is integratedly assisted.

### DISCLOSURE OF THE INVENTION

### Problem to be Solved by the Invention

In the case of editing the page design, various editing functions which the editing application has are used irrespective of an automatic or manual manner. However, particularly, in the case where the general user substantially manually edits the page design, since there is also such a tendency that his design knowledge is insufficient, the edition is not always completed by fully using the functions which the editing application has. In the case where the relevant application has advanced functions and there are many kinds of functions and setting items, there is still more such a tendency that the edition is completed without fully using the functions or without knowing the presence of the more effective functions, and a result which is not preferable as a design is caused.

For example, in the case of arranging a text onto a photograph, in order to improve readability of the text, means for adding a decoration such as outline character or shadow in addition to a method of modifying a text color according to a feature of the photograph is effective. However, there is a case where the edition is finished without executing such a process. In the application for producing the hundreds of page designs as mentioned above, even if one of such text-attributes and text-decorations is considered, when its variations are displayed, the number of combinations is extremely large, the number of page designs which are produced further increases, and the selecting operation becomes difficult.

Even if the desired page design could be found out from the page designs which were automatically produced, since its design is not always perfect, the design is manually adjusted after that in many cases. Therefore, for the general user, even in the case of the page designs which were automatically produced, a function for assisting a more effective design edition in which the subsequent adjusting operation is simpler is demanded.

Although details of various functions are often described in an operation manual or the like, the terminologies are not always disclosed in such a form that they can be easily understood and picture planes and models shown as samples are not always disclosed in such a form that the user can easily image them.

Therefore, means for simply and effectively notifying the user of the kinds of functions which the editing application has and of results which will be obtained by using those functions in order to further improve the page design which is being edited at present is necessary.

### Means for Solving the Problem

To solve the foregoing problem, according to the invention of claim 1, there is provided an apparatus for editing data constructed by raster data, vector data, or characters, comprising: an output unit configured to display the data; and an input unit configured to receive an operation which is executed by a user, characterized by further comprising design modifying means configured to automatically modify a design for one or a plurality of component elements selected by the user by using the input unit.

Further, the invention of claim 2 is characterized in that the design modifying means has a decorating process for the raster data, the vector data, or the character data.

Further, the invention of claim 3 is characterized in that the design modifying means has a color change for the vector data or the character data.

Further, the invention of claim 4 is characterized in that the design modifying means has a trimming position changing process for the raster data.

Further, the invention of claim 5 is characterized in that the design modifying means has an image correcting process for the raster data.

Further, the invention of claim 6 is characterized in that the design modifying means has a position information changing process for the raster data, the vector data, or the character data.

Further, the invention of claim 7 is characterized in that the design modifying means has a size information changing process for the raster data, the vector data, or the character data.

Further, the invention of claim 8 is characterized in that the design modifying means has a rotation or reverse information changing process for the raster data, the vector data, or the character data.

Further, the invention of claim 9 is characterized in that the design modifying means has a process for producing one or a plurality of designs including the component elements and has: design plural candidate display means configured to display the one or plurality of produced designs; and design selecting means configured to develop one of the plurality of design candidates, as an edition target, selected by the user by using the input unit.

Further, the invention of claim 10 is characterized in that the apparatus further comprises means configured to input a region on the data selected by the user by using the input unit, and the design modifying means has a process for arranging the one or plurality of design-modified component elements into the region.

### Advantages of the Invention

According to the invention, for the component elements on the page which has actually been edited, the further-developed design is automatically produced, and the user can be more effectively notified of various editing functions which the page design application has.

### BRIEF DESCRIPTION OF THE DRAWINGS

FIG. 1 is an example of a display screen which displays page design variations.

FIG. 2 is an example of a state where a page design during an edition is displayed.

FIG. 3 is a former half of a processing flow for producing design variations for a single object which is being selected on the page design.

FIG. 4 is a latter half of the processing flow for producing the design variations for the single object which is being selected on the page design.

FIG. 5 is an example of a design modification rule database for a text which is used in a page design variation producing process.

FIG. 6 is an example of a design modification rule database for an image which is used in the page design variation producing process.

FIG. 7 is an example of a design modification rule database for a clipart which is used in the page design variation producing process.

FIG. 8 is a constructional diagram of a temporary saving directory which is used in a page design application.

FIG. 9 is an example of a state where the design selected on a design variation display screen is preview-displayed.

FIG. 10 is a processing flow for producing design variations for multiple objects which are being selected on the page design.

FIG. 11 is an example of a design modification rule database for multiple objects which is used in the page design variation producing process.

FIG. 12 is an example of an object expanding/contracting process upon production of page design variations.

FIG. 13 is an example of an object rotating process upon production of page design variations.

FIG. 14 is an example of an aligning process in the lateral direction upon production of page design variations.

FIG. 15 is an example of an object layout in the case where the aligning process cannot be executed upon production of the page design variations.

FIG. 16 is an example of a display screen which displays page design variations for multiple objects.

FIG. 17 is an example of a display screen after selection of page design variations for the multiple objects.

FIG. 18 is an example of a format on a page design file.

FIG. 19 is a constructional diagram of an apparatus in which a page design application operates.

### BEST MODE FOR CARRYING OUT THE INVENTION

An automatic producing function of page design variations including data constructed by raster data, vector data, or characters which operates as a part of application software on a personal computer (hereinbelow, abbreviated to “PC”) according to an embodiment of the invention will be described hereinbelow with reference to the drawings. A page design serving as an edition target of the application may be a general office document or a use-specified document such as poster, postcard, or presentation data. The page design application has various functions in order to edit the page design and can execute a resizing, a movement, and a rotation for a page component element, a correcting process and a text edition for an image, and a decorating process and background setting for a photograph and a text. In the following embodiment 1, processes upon selection of a single object are shown. In the following embodiment 2, processes upon selection of multiple objects are shown.

### Embodiment 1

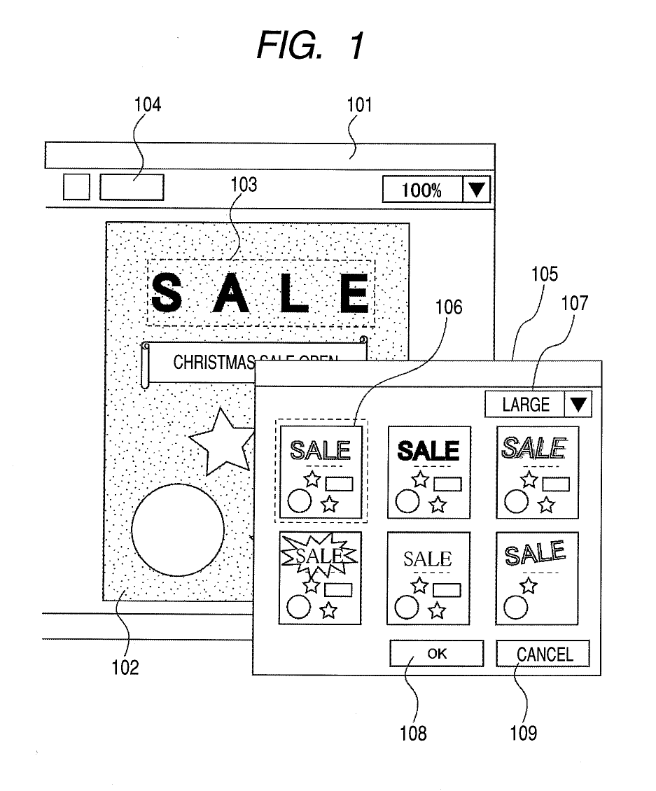

FIG. 1 shows an example of a display screen which displays page design variations serving as an embodiment of the invention. In this instance, a state where one certain text object on a page design which is being edited is selected, a command for design variations such as menu or button is executed, and thereafter, a plurality of page designs are displayed as a list in a thumbnail size is illustrated. If there is a desired design, by selecting a corresponding thumbnail on the page design list and selecting an OK button on the display screen, the page design during the edition can be replaced by the selected design.

A main display screen 101 of a page design application to which the invention is embodied is illustrated. The main display screen of the application has a display screen for displaying design elements such as menu, toolbar, button, photograph, clipart, picture frame, text-decoration, and background corresponding to various processes (hereinbelow, those design elements are generally referred to as “artworks”) as a list. The application has a region for displaying the selected page design in an edition target document (hereinbelow, such a region is called “preview region”). In the preview region, the operation such as movement or resizing for the component elements on the page design (hereinbelow, each of those component elements is generally referred to as “object”) can be executed. The operation by the command or user is executed by using an input unit such as mouse or keyboard connected to the PC.

The whole page design which is being edited at present is displayed in a preview region 102. In the embodiment, although a document constructed by one page is used as an edition target, a document having a plurality of pages may be used as an edition target. In this case, the application has a page moving command for moving to an arbitrary page and has to be constructed so that the edition target can be moved to the user's desired page. In addition, the apparatus can be also constructed so that it has an edition assisting function such as guide, grid, and ruler and can smoothly perform the layout of objects to intended positions.

A region 103 shows that a text object “SALE” on the page design is in a selecting state. The user can set a desired object into a selecting state by the clicking operation by a mouse or by executing the keyboard operation by a TAB key.

A design variation producing button 104 is shown on the toolbar. Other processing buttons and a display magnification designation drop-down list of the preview region are arranged on the toolbar. When the design variation producing button is clicked, a variation in which a design of the single object selected on the preview has been changed is automatically produced with respect to the whole page design including the object and its result is displayed onto a design candidate display screen 105, which will be described hereinafter. If there are not selecting objects on the page design, the relevant button may be invalid-displayed and may be set into a selection impossible state.

Page designs which are automatically produced by the design variation producing button 104 are thumbnail-displayed on a design variation display screen 105. In the embodiment, the design variations for the selected object 103 are realized by using the function which the relevant application has. For example, results obtained by applying an outline character, a character shadow, a text-decoration, a rotation, or their combination are displayed as sample examples. According to any of those thumbnails, since the whole page design including the object 103 is displayed, how an impression of the page design is changed by a design modification of the relevant object can be compared.

A page design 106 during the selection is shown. When an OK button 108 is selected, the page design 106 is developed into the preview region 102. If the page design in the preview region 102 is being edited and is in a state where it is not saved in a file system of the PC, the relevant application displays a warning, thereby promoting the user to save the page design.

In a drop-down menu 107 for changing a display size of the produced page design image, any one of the large, middle, and small sizes can be selected.

Details of processes which are executed until the page design list is displayed after the design variation producing button was selected will be described hereinafter.

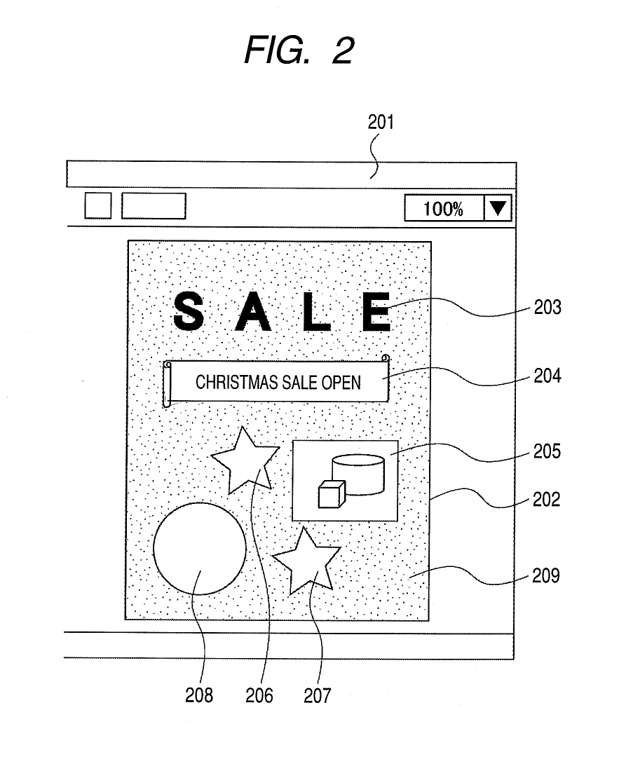

FIG. 2 illustrates a state where the page design during the edition is displayed by the application according to the embodiment of the invention.

A main display screen 201 of the page design application similar to the main display screen 101 is illustrated. A page design 202 during the edition is displayed in the preview region. Multiple objects are arranged in the page design. That is, texts (203, 204), a picture-object (205), cliparts (206, 207), a rectangle (208) as a kind of figure, and a background (209) are arranged. Among them, a text-decoration of rolled paper as a motif is applied to the text 204. A rotation is applied to the clipart 206. The user can apply position rotation information and a decoration to those objects, so that the impression of the page design which the reader and observer will have can be changed.

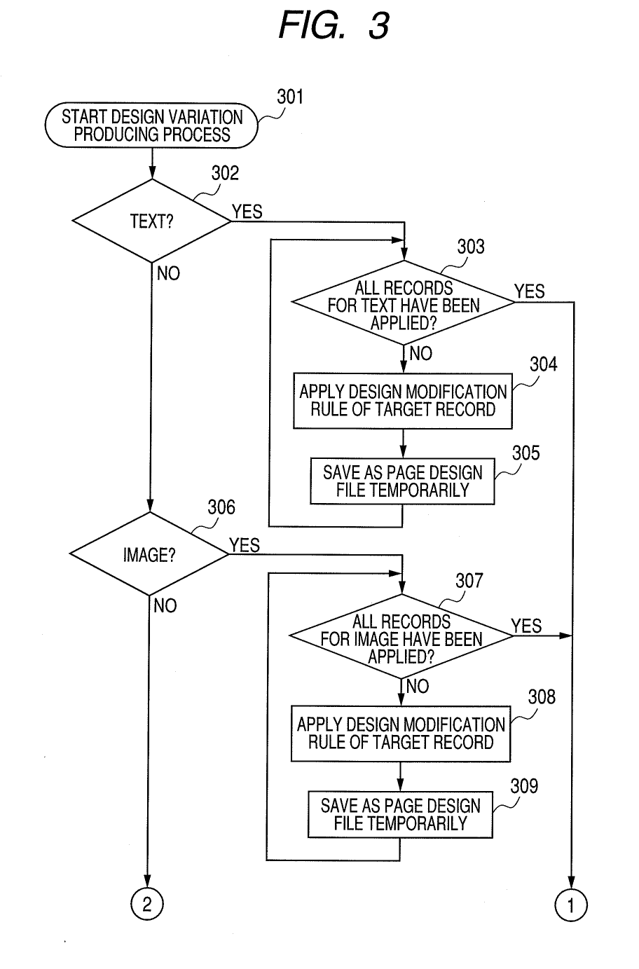

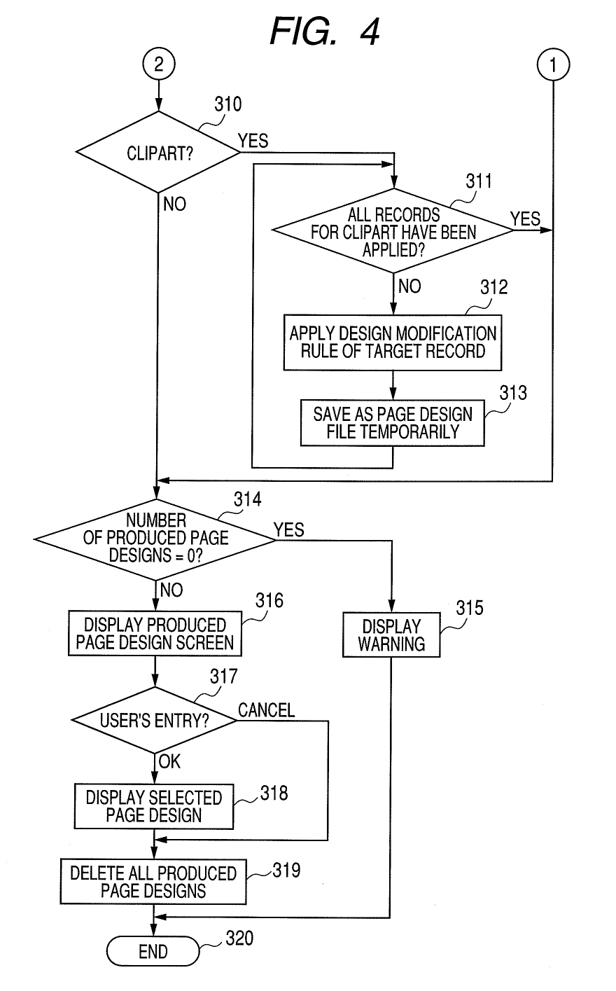

FIGS. 3 and 4 are processing flows for producing design variations for the single object which is being selected on the page design according to the embodiment of the invention.

A design variation producing process is started in 301 and corresponds to the process upon selection of the design variation producing button 104. A process for discriminating whether or not a type of the object during the selection indicates a text is executed in 302. In the case of the text object, the processing routine advances to 303 and a design modification rule for the text is applied. Similarly, a process for discriminating whether or not a type of the object during the selection indicates an image is executed in 306 and a process for discriminating whether or not a type of the object during the selection indicates a clipart is executed in 310. If a discrimination result is YES, the processing routine advances to 307 and 311, respectively, and the corresponding design modification rule is applied.

Processes for producing page designs obtained by applying each rule in a database of the design modification rules for the text (hereinbelow, abbreviated to T-DB) to the selected object and saving them into a temporary saving directory are repetitively executed in 303 to 305. If unprocessed items in the T-DB which are applied still remain in 303, a design modification rule applying process in 304 is executed. If any unprocessed item does not remain, the processing routine advances to a process in 314.

In 304, the items in the T-DB are discriminated and the design modification rule for the selected object is applied. To prevent an influence from being exerted on the page design displayed on the preview display screen, the rule applying process is executed to copied page design data. At this time, the data may be page design data copied into the memory or the file system. In the case where the design modification rule has been applied to the page design data copied into the memory, a result obtained by applying such a rule is also held in the memory. The design modification rule in the T-DB will be described hereinafter.

In 305, the page design data to which the design modification rule has been applied in 304 is saved into the temporary saving directory in the file system. At this time, a name of file which is saved may be an arbitrary name so as to be unique in the temporary saving directory. Details of the temporary saving directory will be described hereinafter.

In 307 to 309, in a manner similar to 304 and 305, processes for producing page designs obtained by applying each rule in a database of the design modification rules for the image (hereinbelow, abbreviated to I-DB) to the selected object and saving them into the temporary saving directory are repetitively executed. If items in the I-DB which are applied still remain in 307, a design modification rule applying process in 308 is executed. If any item does not remain, the processing routine advances to the process in 314.

In 308 and 309, processes for discriminating the relevant items in the I-DB, applying the design modification rule for the selected object, and saving results obtained by applying such a rule into the temporary saving directory are executed. The design modification rule in the I-DB will be described hereinafter.

In 311 to 313, processes for producing page designs obtained by applying each rule in a database of the design modification rules for the clipart (hereinbelow, abbreviated to C-DB) to the selected object and saving them into the temporary saving directory are repetitively executed. In a manner similar to the processes for the text object and the image object, if items in the C-DB which are applied still remain in 311, a design modification rule applying process in 312 is executed. If any item does not remain, the processing routine advances to the process in 314.

In 312 and 313, in a manner similar to 304 and 305, processes for discriminating the relevant items in the C-DB, applying the design modification rule for the selected object, and saving results obtained by applying such a rule into the temporary saving directory are executed. The design modification rule in the C-DB will be described hereinafter.

In 314, the number of page design files in the temporary saving directory is discriminated. When the number is equal to 0, the processing routine advances to 315 and a warning showing that the process has been stopped because the applied design modification rule could not be found out or some error occurred is displayed. In 320, the design variation producing process is finished. For example, in the embodiment, if the selected object is a group object in which the objects have been defined in a grouped state, since the corresponding design modification rule database is not provided, the above situation corresponds to this case.

In 316, the design variation display screen is displayed and all page designs in the temporary saving directory are displayed as a list by contraction images. The contraction images of the page designs which are displayed here are image information embedded in the page design files. A format of the page design files will be described hereinafter.

In 317, a user's entry on the design variation display screen is waited for. If the OK button is selected on the display screen by the user, the processing routine advances to 318 and a process for developing the selected page design is executed. If a cancel button is selected, the processing routine advances to 319 and all of the page design files saved in the temporary saving directory are deleted.

In 318, processes for opening the page design file corresponding to the item selected on the page variation display screen and replacing the data which is developed on the page preview are executed. If the page designs which have already been developed are in an unsaved state, the warning to promote the user to save them is displayed as mentioned above. It is assumed that such a process is also included in 318.

In 319, all of the page design files in the temporary saving directory saved in 305, 309, and 313 are deleted. In 320, the design variation display screen is closed and the design variation producing process is finished.

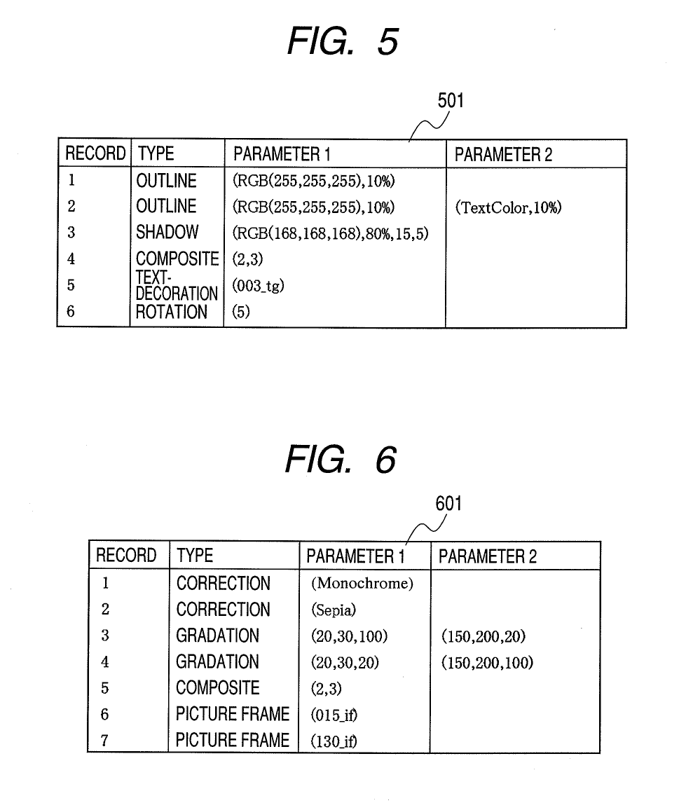

FIG. 5 shows the design modification rule database T-DB for the text which is used in the application according to the embodiment of the invention. Each record in the T-DB corresponds to each applying rule and has been defined as row data. In a table 501 as an example of the T-DB, an outline character, a character shadow, a composite application, a text-decoration, and a rotation are defined as types. Their processing parameters are defined as attributes of a parameter 1 and a parameter 2 in the T-DB and their interpretations differ depending on the applying type. For example, in the rule of No. 1, since there is only one defined parameter, the outline character is set to a single layer, the color of the outline is set to white (R=255, G=255, B=255), and a thickness is set to 5% of a font size of the relevant text. In the rule of No. 2, since there are two defined parameters, the outline attribute is set to a double layer and the colors and thicknesses of the inside and outside outlines are defined in the parameter 1 and the parameter 2, respectively. Particularly, in the parameter 2, it is designated that as a color of the outline, the color of the selected text is used instead of a specific color. In the rule of No. 3, the rule which applies the character shadow is shown and the color of the shadow and values of an opaqueness degree, an angle, and a width as character shadow parameters have been defined in the parameter 1. In the rule of No. 4, the composite application is shown and it has been defined that the rules of Nos. 2 and 3 are sequentially applied. That is, as a result of application of the design modification rule, the text object with the double-layered outline character and character shadow is obtained. In the rule of No. 5, the text-decoration is applied and an artwork ID (ID which is allocated every artwork) of the text-decoration has been defined. In the rule of No. 6, the rotation is applied and the angle designated in the parameter 1 is applied to the selected text.

FIG. 6 shows the design modification rule database I-DB for the image which is used in the application according to the embodiment of the invention. Also in the I-DB shown at 601, in a manner similar to the T-DB, types and parameters have been defined on a rule unit basis and interpretations of the parameters differ depending on the applying type. The rules of Nos. 1 and 2 relate to the image correction and it has been defined that a monochromatic process and a sepia process are respectively executed to the selected image. The rules of Nos. 3 and 4 relate to gradation setting using the opaqueness degree. Coordinates and an opaqueness degree of a gradation start position and coordinates and an opaqueness degree of an end position have been defined as a parameter 1 and a parameter 2 for the selected image, respectively. According to the gradation setting of No. 3, it is interpreted that the opaqueness degree of the start point (20, 30) is equal to 100% and the opaqueness degree of the end point (150, 200) is equal to 20%. Thus, it is shown that such a gradation effect that the opaqueness degree decreases from the upper left position toward the lower right direction of the image is obtained. The rule of No. 5 relates to the composite application and it has been defined that the rules of Nos. 2 and 3 are applied, respectively. That is, the selected image is corrected in sepia and such the gradation effect of the opaqueness degree is applied from the upper left position toward the lower right position of the image. The rules of Nos. 6 and 7 relate to the application of the picture frames and artwork IDs of the picture frames have been defined, respectively. The rule of No. 8 relates to the rotation and the angles designated in the parameter 1 are applied to the selected image.

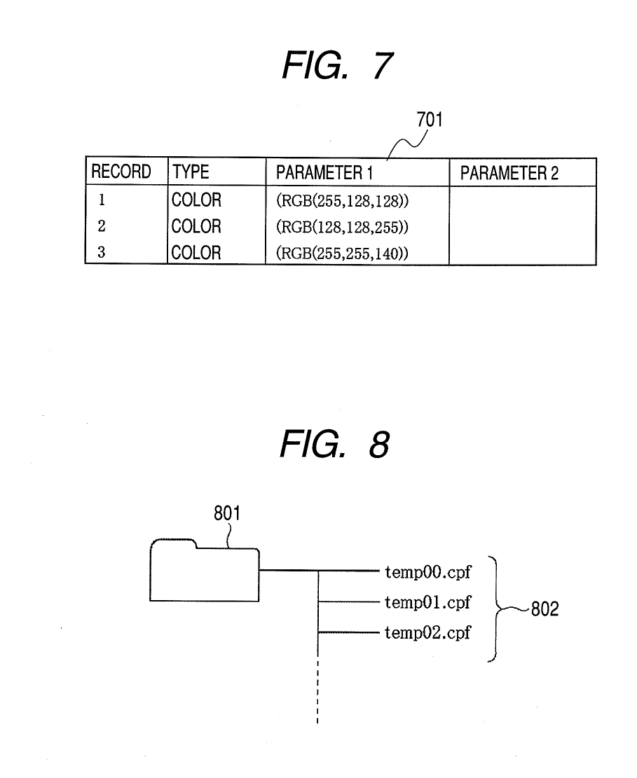

FIG. 7 shows the design modification rule database C-DB for the clipart which is used in the application according to the embodiment of the invention. The rules of Nos. 1, 2, and 3 relate to the color change and the colors defined in the parameter 1 are applied to the selected clipart, respectively. The application has a function for changing the color of the whole clipart serving as a target based on the designated color. If there is one region which constructs the clipart, the whole clipart is painted in the designated color. If the clipart is constructed by a plurality of regions, it is constructed by a main region having a reference color (region which decides the impression of the whole clipart) and other regions. The colors of the other regions (hereinbelow, referred to as “other region colors”) are determined based on the reference color. Relations between the reference color and the other region colors are defined every clipart. For example, a certain clipart can have such a rule that the other region colors have a predetermined brightness difference from the reference color. Thus, by designating the color of the clipart, the color arrangement of the whole clipart is changed and there is a possibility that the appearance impression changes largely. The rule of No. 4 relates to the rotation and the angles designated in the parameter 1 are applied to the selected clipart.

FIG. 8 is a constructional diagram of the temporary saving directory which is used in the application according to the embodiment of the invention. A directory 801 and page design files 802 which are formed by the design variation producing process are illustrated. The number of page design files depends on the type of object selected at the start of 301, that is, the definition of the design modification rule database corresponding to the selected object. The page design files are automatically deleted after completion of the design variation production. As for the location of the temporary saving directory, the application may statically hold it or the user can also properly change it according to a construction of the PC.

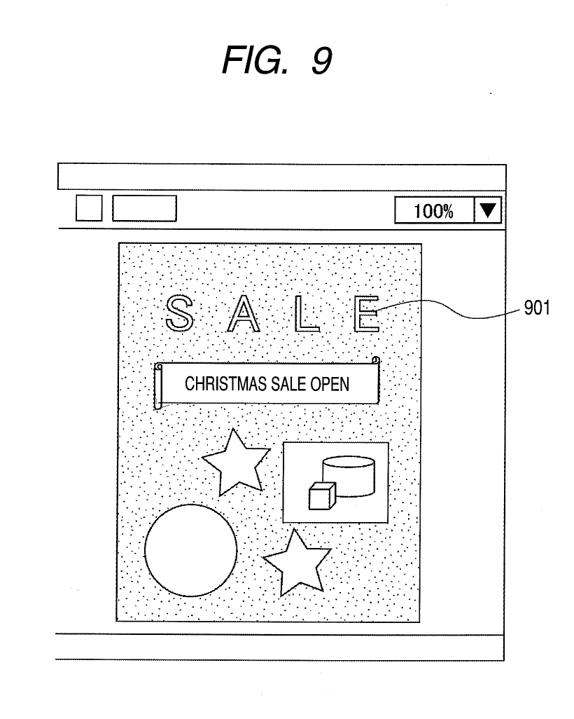

FIG. 9 illustrates a state where the produced design selected on the design variation display screen is preview-displayed according to the embodiment of the invention. Although the screen displayed before the design variation display screen illustrated at 103 is a plain text, outline characters are added in 901 and the impression of the page design has changed.

### Embodiment 2

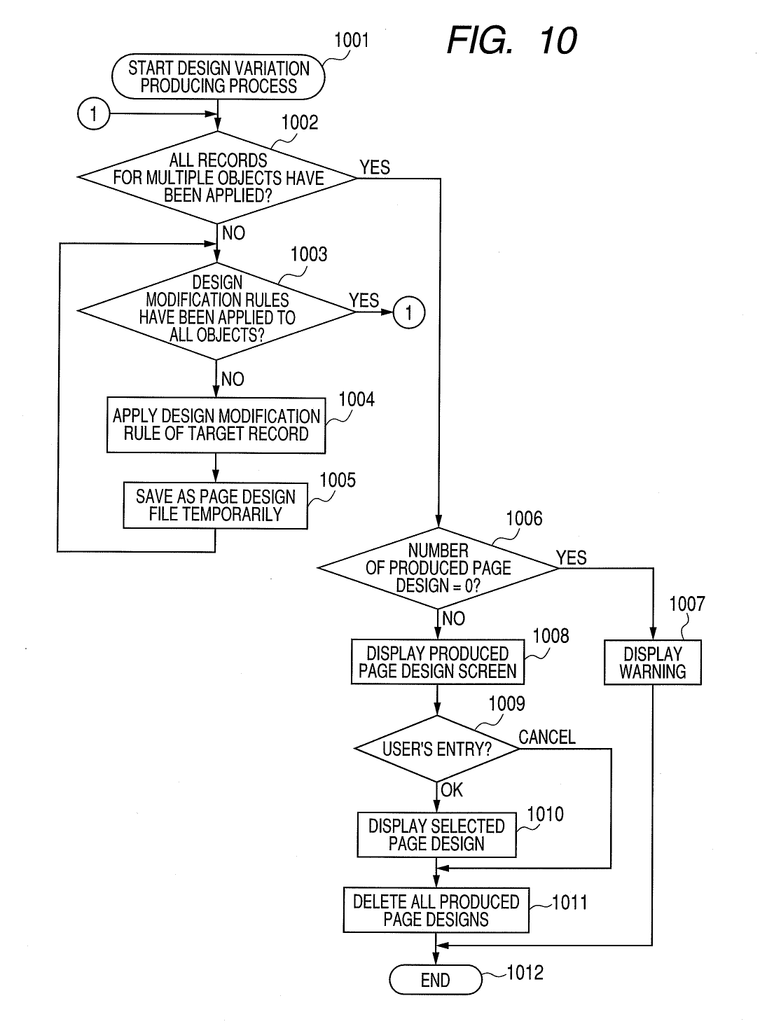

FIG. 10 is a processing flow for producing design variations for multiple objects which are being selected on the page design according to the embodiment of the invention. In the embodiment, the type of target object is not limited, that is, the processes according to the object type are not executed. The multiple object selecting operation is executed by using a SHIFT key or a CTRL key together with the mouse clicking operation.

The design variation producing process is started in 1001. This processing routine corresponds to the process upon selection of the design variation producing button 104. Subsequently, the processing routine advances from 1002 to 1005 and a design modification rule for the multiple objects is applied. Thereafter, the processing routine advances to 1006.

In 1002 to 1005, processes for producing page designs obtained by applying each rule in a database of the design modification rules for the multiple objects (hereinbelow, abbreviated to M-DB) to the selected object and saving them into the temporary saving directory are repetitively executed. In addition, in 1003 to 1005, the rule applying process is repetitively executed to each object which is being selected.

If the unprocessed items in the M-DB which is applied still remain in 1002, a design modification rule applying process of 1003 is executed. If any unprocessed item does not remain, the processing routine advances to the process of 1006. In 1003, whether or not the rule has already been applied to all of the selected objects is discriminated. If there are the objects to which the rule is not yet applied, the processing routine advances to the process of 1004 and the rule applying process is executed. The same rule and parameters are not always applied to all of the objects. This point will be described in detail hereinafter.

Processes in 1004 and 1005 are the same as those of 304 and 305, respectively, and the rule is applied and its results are stored as page design files into the temporary saving directory. The process in 1006 and subsequent processes are the same as that in 314 and subsequent processes.

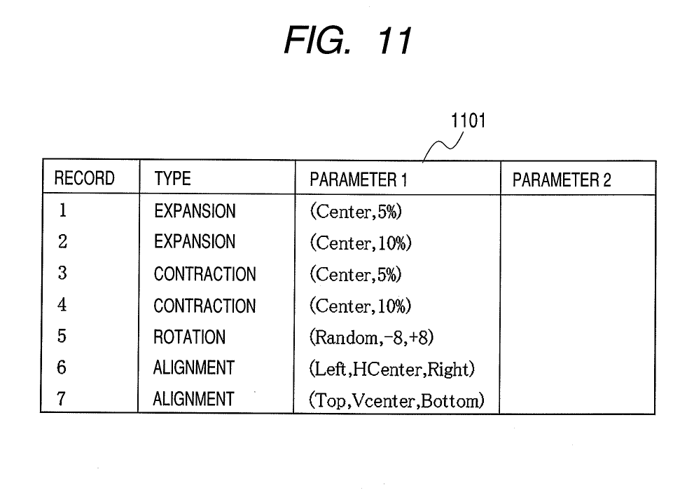

FIG. 11 shows a database M-DB of the design modification rule for the multiple objects which is used in the application according to the embodiment of the invention. In a manner similar to 401, 501, and 601, each record in the M-DB corresponds to each applying rule and has been defined as row data. In a table 1101 as an example of the M-DB, an expansion, a contraction, a rotation, and an alignment have been defined as types. Specific examples of those processes will be described hereinafter. The rules of Nos. 1 and 2 relate to the expanding process and such a process that a center position of the object is fixed and each side is expanded by 5% and 10% has been defined. The same process is applied to all of the target objects. The rules of Nos. 3 and 4 relate to the contracting process and such a process that a contraction of 5% and 10%, respectively, is performed has been defined. In a manner similar to Nos. 1 and 2, as for the rule, the same process is also applied to all of the target objects. The rule of No. 5 relates to the rotating process and such a process that random rotational angles in a range from −5° to 5° are sequentially applied as parameters to the target objects is executed. The rules of Nos. 6 and 7 relate to the aligning process and processes for aligning a group of selected objects in the lateral direction and in the vertical direction are applied, respectively. As an aligning process in the lateral direction, a left-justification, a center-justification, and a right-justification are executed. In the left-justification, the selected objects are aligned by using the object at the leftmost edge as a reference. In the center-justification, the selected objects are aligned by using the center in the lateral direction in a circumscribed rectangle of the selected object group as a reference. In the right-justification, the selected objects are aligned by using the object at the rightmost edge as a reference. Similarly, as an aligning process in the vertical direction, an upper-justification, a center-justification, and a lower-justification are executed. In the upper-justification, the selected objects are aligned by using the object at the top edge as a reference. In the center-justification, the selected objects are aligned by using the center in the vertical direction in the circumscribed rectangle of the selected object group as a reference. In the lower-justification, the selected objects are aligned by using the object at the bottom edge as a reference. By executing the aligning process, the selected objects are mutually overlaid, so that there can be also a case where a good outward appearance deteriorates obviously in terms of design. In order to cope with such a case, such a procedure that whether or not the aligning process can be applied is discriminated and only when it can be executed, the aligning process is executed. Details of the process for discriminating whether or not the aligning process can be applied will be described hereinafter.

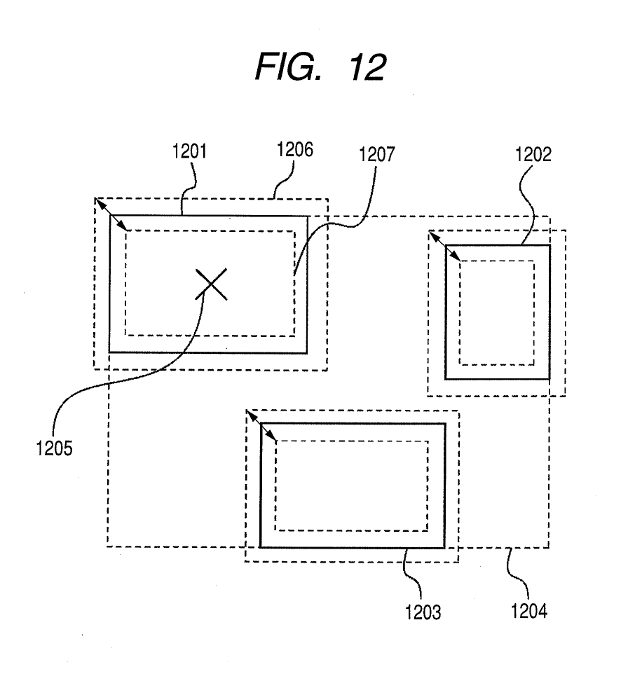

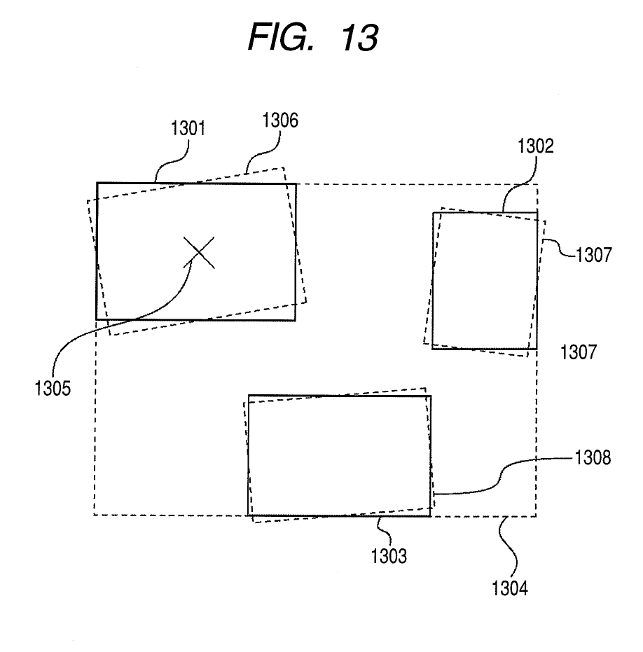

FIG. 12 is an example of an object expanding/contracting process in the application according to the embodiment of the invention. Objects 1201, 1202, and 1203 are in a selecting state on the page design during the edition. A region 1204 is occupied by the selected object group (hereinbelow, such a region is called “selected object region”). The selected object region is defined as a minimum rectangle surrounding all of the selected objects. The expanding/contracting process is executed by using the center of the object as a reference. A center position 1205 of the object 1201 is shown. Examples in which the object 1201 has been expanded and contracted by using the center position as a reference are illustrated at 1206 and 1207, respectively. Thus, according to the expanding/contracting process, a size of selected object region is changed.

FIG. 13 is an example of an object rotating process in the application according to the embodiment of the invention. Objects 1301, 1302, and 1303 are in a selecting state on the page design during the edition. A selected object region 1304 is illustrated. In a manner similar to the foregoing expanding/contracting process, the rotating process is executed by using the object center as a reference. A center position 1305 of the object 1301 is shown. An example in which the object 1301 has been rotated counterclockwise by 5° by using the center position as a reference is illustrated at 1306. Examples in which the object 1301 has been also rotated clockwise by 3° and rotated counterclockwise by 5°, respectively, are illustrated at 1307 and 1308.

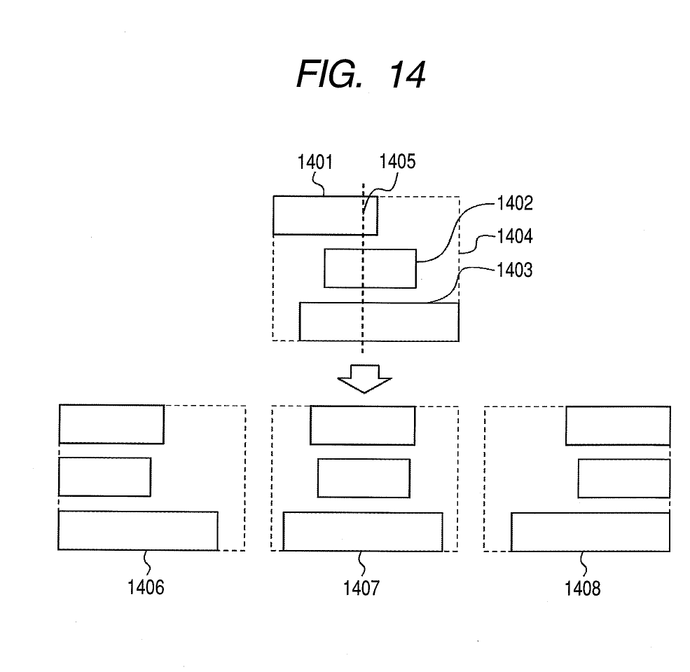

FIG. 14 is an example of an aligning process in the lateral direction in the application according to the embodiment of the invention. Objects 1401, 1402, and 1403 are in a selecting state on the page design during the edition. A selected object region 1404 is illustrated. A lateral direction center line 1405 of the selected object region is illustrated. Examples in which the left-justification, center-justification, and right-justification have been applied to the selected object, respectively, are shown at 1406, 1407, and 1408. In 1406, the aligning process is applied by using the object 1401 at the leftmost edge as a reference. In 1407, the aligning process is applied by using the center line 1405 as a reference. In 1408, the aligning process is applied by using the object 1403 at the rightmost edge as a reference.

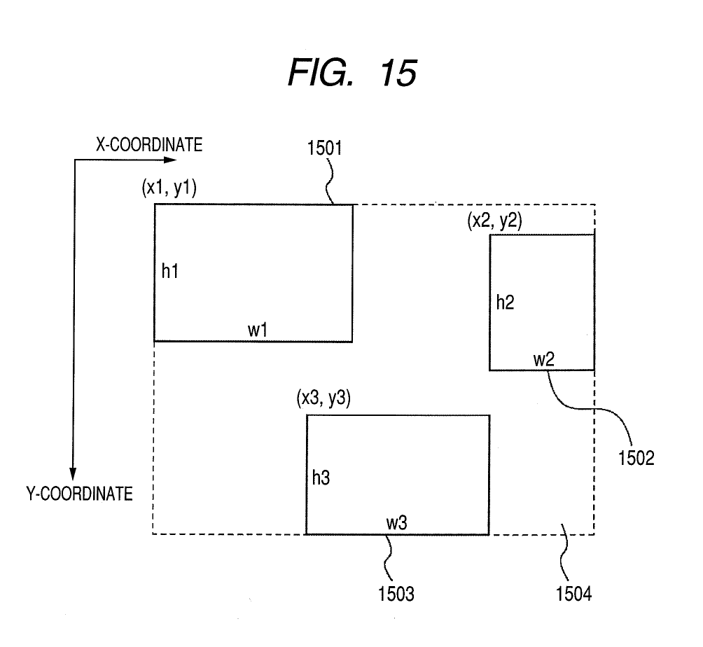

FIG. 15 is an example of an object layout in the case where the aligning process in the application cannot be executed, according to the embodiment of the invention. Objects 1501, 1502, and 1503 are in a selecting state on the page design during the edition. A selected object region 1504 is illustrated. Position information and size information of the objects are (x1, y1, w1, h1), (x2, y2, w2, h2), and (x2, y2, w2, h2), respectively. A coordinate system uses the upper left position as an origin and uses a position of the upper left vertex of the object as position information. That is, the object 1501 shows that upper left coordinates are equal to x1 and y1, a width is equal to w1, and a height is equal to h1. In the case of applying the alignment in the lateral direction, a position in an x direction in each of the group of objects changes. However, since (y1+h1<y2), even if any one of the left-justification, center-justification, and right-justification is executed, the objects 1402 and 1401 overlap. Similarly, since (x1+w1<x2) and (x2+w2<x3), even if any one of the upper-justification, center-justification, and lower-justification is executed, the objects 1502, 1501, and 1503 overlap. Therefore, in the application, it is determined that the aligning process which causes such an overlap cannot be applied, and the saving process in 1005 is skipped.

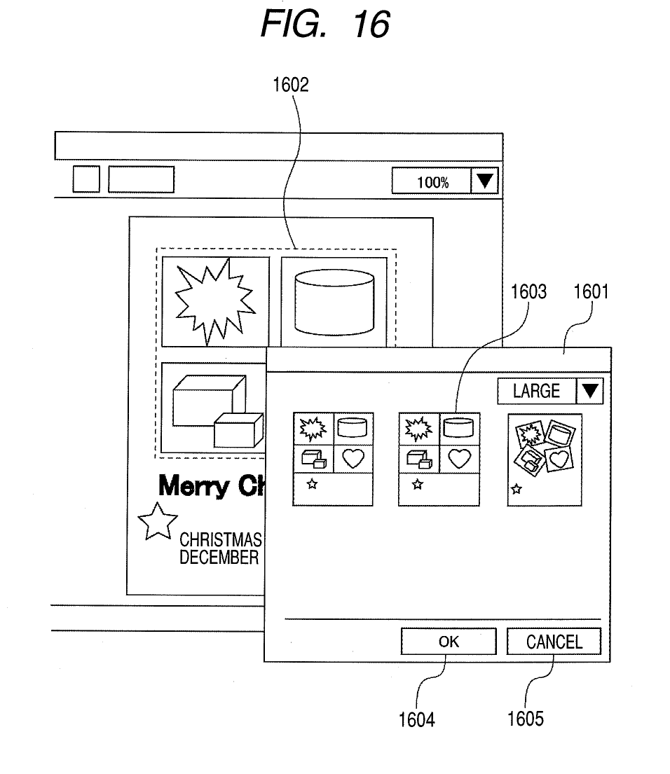

FIG. 16 is an example of a display screen which displays page design variations for the multiple objects in the application according to the embodiment of the invention. An object group 1601 is selected on the page design which is being edited. A design variation display screen 1602 for the object group 1601 is illustrated and three produced design variations are displayed there. They relate to results in which the expansion, expansion, and rotation have been applied, respectively. It is illustrated that a design 1603 in the produced design variations is in a selecting state. In a manner similar to 108 and 109, an OK button 1604 and a cancel button 1605 are provided.

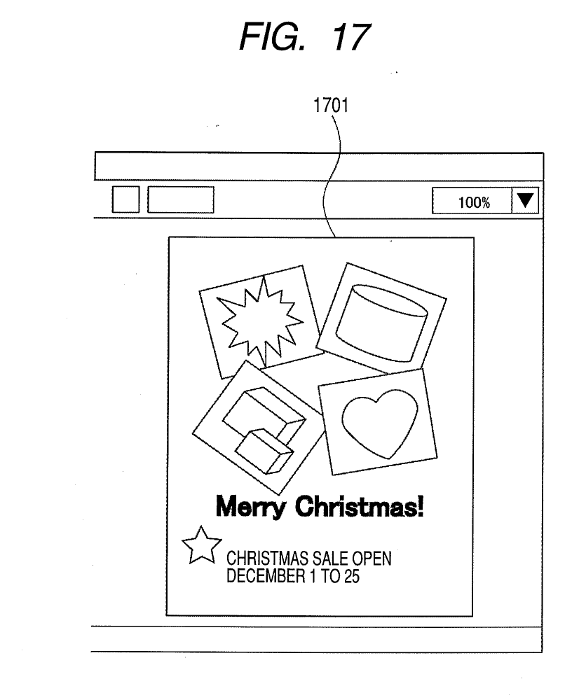

FIG. 17 is an example of a display screen after the selection of the page design variations for the multiple objects in the application according to the embodiment of the invention. A state 1701 where the page design 1603 has been developed in the preview region by clicking the button 1604 in the state of FIG. 15 is illustrated.

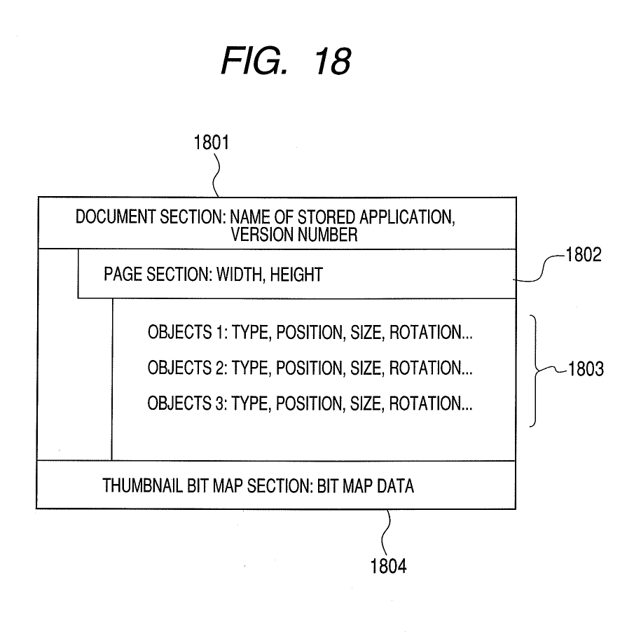

FIG. 18 is an example of a format on the page design file which is used in the application according to the embodiment of the invention. A version name of the produced application serving as attributes of the whole page design is shown at 1801. Information 1802 and 1803 of each page is stored. There is also a state where a plurality of pages is held in a document. In such a case, the sections 1802 and 1803 are repetitively held. In the information 1802 peculiar to the page, a page size, blank space information, and a background object have been defined. Information such as type, position, size, rotation of the object, and the presence or absence of a decoration such as picture frame or text-decoration serving, as attributes of the object group which the page design has, has been defined in 1803. Bit map data of a thumbnail image showing the page design has been defined in 1804 and is used upon displaying on the page design variation display screen 105 or 1602.

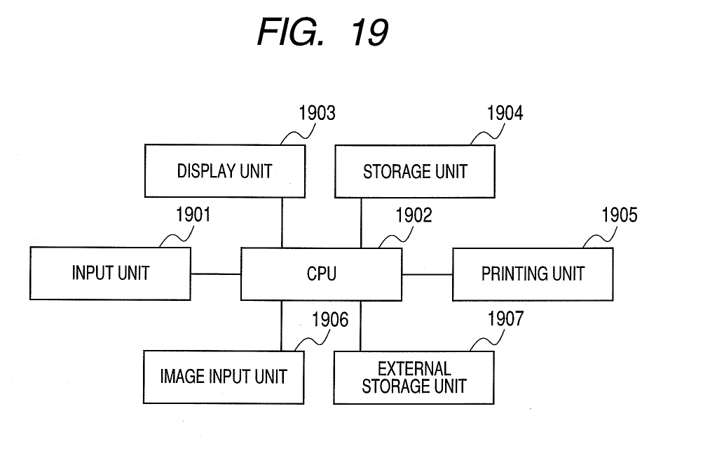

FIG. 19 is a constructional diagram of an apparatus in which the page design application operates according to the embodiment of the invention.

In the diagram, an input unit 1901 such as keyboard, mouse, or the like is provided. A central processing unit 1902 executes management control of the system, an input and correction of an input image, a producing process of edition data for printing, etc. A display 1903 is used for displaying. A storage unit 1904 such as a hard disk or the like for storing the image data file and a corresponding image correcting command history file is provided. A printing unit 1905 outputs the edition data. An image input unit 1906 such as film scanner, flat-bed scanner, digital camera, or the like is provided. An external storage unit 1907 corresponding to a floppy disk (registered trademark) or a medium which is used in a drive, a digital camera, or the like is provided.

Among the processes which are applied to the single object in the embodiment 1, the parameters such as outline character, character shadow, color change, and the like have statically been defined in the corresponding design modification rule. However, they may be defined so that they operate dynamically according to the position of the selected object or other attributes. For example, when the selected object is a text, such a process as to dynamically setting the color of the outline and the color of the character shadow based on the background color of the text and the color of the text may be executed. In the case of the group objects, the design modification rule may be recursively applied to each object belonging to the group.

Among the processes which are applied to the multiple objects in the embodiment 2, the parameters such as expanding/contracting process and rotating process have also statically been defined in the corresponding design modification rule. However, they may be defined so that they operate dynamically according to the position of the selected object or other attributes. In addition, in the expanding/contracting process, they may be defined so that the object is expanded and contracted to lie within the selected object region, without changing the region. In the aligning process, a process for uniforming a blank space between the objects and a dynamic process for displaying the optimum alignment among the three alignment types based on the position between the objects may be executed. In addition, in the case where the user selects a rectangular region by the mouse dragging operation and produces design variations for the objects existing in such a region, the layout information may be changed so as to lie within the selected region instead of the selected object region. For example, when a region which largely surrounds the multiple objects is selected, such a design modifying process that the objects are arranged closely inside of the selected region may be executed.

Although the processes regarding the single selected object has been shown in the embodiment 1 and the processes regarding the multiple selected objects has been shown in the embodiment 2, the processes in which those processes are combined, that is, the design modification rule for the single selected object may be applied to the multiple selected objects. Thus, such a result that in a state where a plurality of texts has been selected, page design variations in which the outline characters have been added to all of the texts and aligned are produced can also occur.

According to the above embodiments, in addition to that the variations of the selected object are automatically produced, since a plurality of design modification types and their effects can be displayed, the general user can easily know a possibility of the further modified designs while visually comparing them.

The present application claims the priority right based on Japanese patent application No. 2006-330691 filed on Dec. 7, 2006, the content of which is hereby incorporated by reference into this application.

1. A design editing apparatus for editing data constructed by raster data, vector data, or character data, comprising: an output unit configured to display the data; and an input unit configured to receive an operation which is executed by a user, wherein the apparatus further comprises design modifying means configured to automatically modify a design for one or a plurality of component elements selected by the user by using the input unit.

2. A design editing apparatus according to claim 1, wherein the design modifying means has a decorating process for the raster data, the vector data, or the character data.

3. A design editing apparatus according to claim 1, wherein the design modifying means has a color change for the vector data or the character data.

4. A design editing apparatus according to claim 1, wherein the design modifying means has a trimming position changing process for the raster data.

5. A design editing apparatus according to claim 1, wherein the design modifying means has an image correcting process for the raster data.

6. A design editing apparatus according to claim 1, wherein the design modifying means has a position information changing process for the raster data, the vector data, or the character data.

7. A design editing apparatus according to claim 1, wherein the design modifying means has a size information changing process for the raster data, the vector data, or the character data.

8. A design editing apparatus according to claim 1, wherein the design modifying means has a rotation or reverse information changing process for the raster data, the vector data, or the character data.

9. A design editing apparatus according to claim 1, wherein the design modifying means has a process for producing one or a plurality of designs including the component elements, said design modifying means comprising: design plural candidate display means configured to display the one or plurality of produced designs; and design selecting means configured to develop one of the plurality of design candidates, as an edition target, selected by the user by using the input unit.

10. A design editing apparatus according to claim 1, further comprising means configured to input a region on the data selected by the user by using the input unit, and wherein the design modifying means has a process for arranging the one or a plurality of design-modified component elements into the region.

11. A design editing method of editing data constructed by raster data, vector data, or character data, comprising: an outputting step of displaying the data; and an inputting step of receiving an operation which is executed by a user, wherein the method further comprises a design modifying step of automatically modifying a design for one or a plurality of component elements selected by the user by using the inputting step.

12. A design editing method according to claim 11, wherein the design modifying step has a decorating process for the raster data, the vector data, or the character data.

13. A design editing method according to claim 11, wherein the design modifying step has a color change for the vector data or the character data.

14. A design editing method according to claim 11, wherein the design modifying step has a trimming position changing process for the raster data.

15. A design editing method according to claim 11, wherein the design modifying step has an image correcting process for the raster data.

16. A design editing method according to claim 11, wherein the design modifying step has a position information changing process for the raster data, the vector data, or the character data.

17. A design editing method according to claim 11, wherein the design modifying step has a size information changing process for the raster data, the vector data, or the character data.

18. A design editing method according to claim 11, wherein the design modifying step has a rotation or reverse information changing process for the raster data, the vector data, or the character data.

19. A design editing method according to claim 11, wherein the design modifying step has a process for producing one or a plurality of designs including the component elements, said design modifying step comprising: a design plural candidate displaying step of displaying the one or plurality of produced designs; and a design selecting step of developing one of the plurality of design candidates, as an edition target, selected by the user by using the inputting step.

20. A design editing method according to claim 11, further comprising a step of inputting a region on the data selected by the user by using the inputting step, and wherein the design modifying step has a process for arranging the one or a plurality of design-modified component elements into the region.

21. A design editing program characterized by allowing a computer to execute the design editing method according to claim 11.
